(19) United States
(12) Patent Application Publication
(10) Pub. No.: US 2003/0175666 A1
(43) Pub. Date: Sep. 18, 2003

(54) Nutritional guidance system, nutritional guidance apparatus and recording medium

(75) Inventors: Yoshinori Tanabe, Osaka (JP); Hirokazu Genno, Osaka (JP)

Correspondence Address: DARBY & DARBY P.C., Post Office Box 5257, New York, NY, 10150-5257, US

(73) Assignee: SANYO ELECTRIC CO., LTD., Moriguchi City (JP)

(21) Appl. No.: 10/356,647

(22) Filed: Jan. 31, 2003

(30) Foreign Application Priority Data
Jan. 31, 2002 (JP) 2002-024822

(51) Int. Cl. G09B 19/00

(52) U.S. Cl. 434/236; 434/127

(57) ABSTRACT

A nutritional guidance system has a terminal 40 for a patient for transmitting menu information to a server 10, a terminal 30 for a dietitian for accessing the menu information managed by the server 10 and for transmitting, to the server 10, nutritional intake information based on the menu information and nutritional guidance information based on the nutritional intake information, and a terminal 20 for a doctor for transmitting, to the server 10, an access permission to the nutritional guidance information for the terminal 40 for a patient. The server 10 limits access to the nutritional guidance information, which is managed by the server 10, by the terminal 40 for a patient, based on the existence of an access permission from the terminal 20 for a doctor.

### BACKGROUND OF THE INVENTION

1. Field of the Invention

The present invention relates to a nutritional guidance system and a nutritional guidance apparatus for providing nutritional guidance according to a menu, and relates to a recording medium for storing a computer program that allows a computer to provide nutritional guidance according to a menu.

2. Description of Related Art

Nutritional management of the diet (dietary habit management) is widely known as means of health management. Nutritional management of the diet is indispensable for the prevention and treatment of lifestyle diseases such as obesity, high blood pressure and diabetes. Nutritional management is carried out based on, in particular, caloric intake among the nutritional intake of the diet (including content amount of protein, fat, carbohydrate, vitamins, minerals and essential amino acids as well as caloric intake).

It is not, however, easy to find the nutritional intake of the diet because, for example, it is necessary to carefully check the nutritional intake of the respective foods ingested. In addition, it is not easy to evaluate whether or not a balanced diet is achieved. Therefore, in many cases, nutritional management cannot be achieved and is foregone even though the individual retains a concern with it. Though the individual can ask a dietitian for a calculation of nutritional intake and for nutritional guidance (dietary habit guidance), it is rare for the individual who is not obese, who does not have high blood pressure, diabetes, or the like, to visit a hospital as a patient to see a dietitian in order to receive nutritional guidance.

A nutritional guidance service provided on a communications network, such as the Internet, can be utilized as a method for easily receiving calculation of nutritional intake and nutritional guidance. An abstract of the calculation of nutritional intake and of the procedure of nutritional guidance utilizing a communications network is shown in FIG. 1. A terminal 30 to be utilized by a dietitian and a terminal 40 to be utilized by a patient who performs nutritional management are connected through a communications network to a server 10 that provides a nutritional guidance service.

A patient inputs his/her diet menu into the terminal 40 for a patient and transmits the data to the server 10 (arrow (i)). A dietitian peruses the menu, which is received and stored by the server 10, at the terminal 30 for a dietitian (arrow (ii)), and then inputs the nutritional intake information and nutritional guidance information into the terminal 30 for the dietitian and transmits them to the server 10 (arrow (iii)). The patient peruses the nutritional intake information and nutritional guidance information, which are received and stored by the server 10, at the terminal 40 for a patient (arrow (iv)). Image data obtained by taking photographs of the foods in the diet with a digital camera can be used as the diet menu to be transmitted to the server 10. In this case, the dietitian peruses the images to calculate the nutritional intake.

When using a communications network, the individual can receive the calculation of nutritional intake and nutritional guidance by a dietitian solely by inputting and transmitting a diet menu. In addition, it is also possible to receive the calculation of nutritional intake and nutritional guidance by a dietitian solely by transmitting image data of the diet obtained by taking photographs of the foods in the diet with a digital camera.

However, the above described nutritional guidance is carried out by a dietitian. Guidance by a doctor who sees a patient is not included in the nutritional guidance, and thereby the guidance given to the patient is incomplete. Since guidance by a doctor is not included, there is a risk wherein the reliability the patient puts on the nutritional guidance is reduced, or the patient has anxiety.

In addition, though it becomes possible to receive nutritional guidance without going to a hospital, or the like, by utilizing a communications network, it is still important to go to a hospital or the like, in order to receive doctor's diagnosis.

### BRIEF SUMMARY OF THE INVENTION

The present invention has been made with the aim of solving the above problems, and it is an object thereof to provide a nutritional guidance system, a nutritional guidance apparatus and a recording medium with which an access permission to nutritional guidance information for a first apparatus to be utilized by a patient is accepted by an apparatus (third apparatus) to be utilized by a doctor, and thereby access to the nutritional guidance information by the first apparatus can be limited according to the instructions from the doctor.

Another object of the present invention is to provide a nutritional guidance system, a nutritional guidance apparatus and a recording medium with which an instruction for nutritional guidance is accepted by an apparatus to be utilized by a doctor and nutritional guidance information according to the accepted instruction is accepted by a second apparatus to be utilized by a dietitian who has perused the accepted instruction, and thereby nutritional guidance according to the instructions from a doctor can be obtained.

Still another object of the present invention is to provide a nutritional guidance system with which an update of nutritional guidance information by means of a third terminal apparatus to be utilized by a doctor is accepted as an access permission to the nutritional guidance information, and thereby access to nutritional guidance information by a patient can be permitted at the stage where preparation of nutritional guidance information by the doctor has been completed.

Yet another object of the present invention is to provide a nutritional guidance system, a nutritional guidance apparatus and a recording medium with which the date when nutritional guidance information is printed is accepted as an access permission to the nutritional guidance information, and thereby access to nutritional guidance information by a patient is permitted at the stage where preparation of nutritional guidance information by the doctor has been completed and the nutritional guidance information is printed out.

A nutritional guidance system according to the present invention is provided with a central unit, which accepts menu information from a first terminal apparatus, accepts nutritional intake information based on the accepted menu information as well as nutritional guidance information concerning nutritional guidance based on the nutritional intake information from a second terminal apparatus, which displays the accepted menu information, and stores the nutritional intake information and nutritional guidance information. The nutritional guidance system is further provided with a third terminal apparatus which transmits, to the central unit, an access permission to nutritional guidance information for the first terminal apparatus. The central unit accepts an access permission from the third terminal apparatus and limits access to the nutritional guidance information by the first terminal apparatus, based on the existence of the access permission.

A nutritional guidance apparatus according to the present invention accepts menu information from a first apparatus, accepts nutritional intake information based on the accepted menu information as well as nutritional guidance information concerning nutritional guidance based on the nutritional intake information from the second apparatus, which displays the accepted menu information, and stored the nutritional intake information and nutritional guidance information. The nutritional guidance apparatus is provided with acceptance means for accepting an access permission to the nutritional guidance information for the first apparatus, and limits access to the nutritional guidance information by the first apparatus, based on the existence of the access permission.

A recording medium according to the present invention is a recording medium which can be read by a computer and which records a computer program that allows a computer to accept menu information from a first apparatus, to accept nutritional intake information based on the accepted menu information as well as nutritional guidance information concerning nutritional guidance based on the nutritional intake information from the second apparatus, which displays the accepted menu information, and to store the nutritional intake information and nutritional guidance information. The recording medium records a computer program that includes a procedure for allowing a computer to accept an access permission to nutritional guidance information for the first apparatus and a procedure for allowing a computer to limit access to nutritional guidance information by the first apparatus, based on the existence of the access permission.

With the above described nutritional guidance system, nutritional guidance apparatus and recording medium, an access permission to nutritional guidance information for the first apparatus is accepted and access to the nutritional guidance information by the first apparatus is limited based on the existence of the access permission. In a case where the first apparatus is utilized by a patient and an access permission is accepted from the third apparatus utilized by a doctor, an access permission to the nutritional guidance information for the patient is given by the doctor. That is to say, access to the nutritional guidance information by the patient can be limited until the doctor grants permission. The doctor can give an instruction such that access to the nutritional guidance information by the patient is refused/allowed before/after the doctor sees the patient. Accordingly, the nutritional guidance information that the patient can access is sufficiently reliable because it is information confirmed and authorized by a doctor.

In the nutritional guidance system according to the present invention, the third terminal apparatus may transmit an instruction for nutritional guidance to the central unit, and the central unit may receive the instruction for nutritional guidance from the third terminal apparatus and accept nutritional guidance information concerning nutritional guidance in accordance with the accepted instruction from the second terminal apparatus, which displays the accepted instruction.

In the nutritional guidance apparatus according to the present invention, the acceptance means may be formed so as to accept an instruction for nutritional guidance and accept nutritional guidance information concerning nutritional guidance in accordance with the accepted instruction from the second apparatus, which displays the accepted instruction.

In the recording medium according to the present invention, the computer program may further include a procedure for allowing a computer to accept an instruction for nutritional guidance and a procedure for allowing a computer to accept nutritional guidance information concerning nutritional guidance in accordance with the accepted instruction from the second apparatus, which displays the accepted instruction.

With the above described nutritional guidance system, nutritional guidance apparatus and recording medium, an instruction for nutritional guidance is accepted and nutritional guidance information concerning nutritional guidance in accordance with the accepted instruction is accepted from the second apparatus, which displays the accepted instruction. In a case where a dietitian utilizes the second apparatus and an instruction for nutritional guidance is accepted by the third apparatus utilized by a doctor, an instruction for nutritional guidance for each patient is given to the dietitian by the doctor. In a case where, for example, a patient is suffering from a stomach disease, an instruction concerning advice to follow a diet that results in a small burden on the stomach is given. Accordingly, the dietitian can prepare nutritional guidance information that is optimal for the patient, based on the instructions from the doctor.

In the nutritional guidance system according to the present invention, the third terminal apparatus may be provided with update means for updating nutritional guidance information stored in the central unit so as to accept nutritional guidance information updated by the third terminal apparatus as an access permission to the nutritional guidance information.

With this nutritional guidance system, nutritional guidance information updated by the third terminal apparatus utilized by a doctor is accepted as an access permission to the nutritional guidance information. In a case where the doctor has updated nutritional guidance information utilizing the third terminal apparatus, it is highly probable that nutritional guidance by the dietitian has been confirmed and input of a comment for the nutritional guidance information has been completed. Accordingly, an access permission can be given at the stage where the confirmation of nutritional guidance and input of the comment by the doctor has been completed. In the case where the confirmation of nutritional guidance and the input of a comment by the doctor have been completed, the nutritional guidance information is completed and no problem occurs when the patient peruses it.

In the nutritional guidance system according to the present invention, the third terminal apparatus may be provided with printing means for printing out nutritional guidance information stored in the central unit and with transmission means for transmitting a notice of completion of printing to the central unit, so that the central unit accepts the notice of completion of printing of the nutritional guidance information as an access permission to the nutritional guidance information.

In the nutritional guidance system according to the present invention, the third terminal apparatus may be provided with means for transmitting, to the central unit, a send-back request indicating a request for sending the nutritional guidance information back to the second terminal apparatus, and the central unit may store an evaluation table in which evaluation points changing according to an access permission or a send-back request accepted from the third terminal apparatus are set, so as to determine whether an access permission to the nutritional guidance information is to be transmitted to the first terminal apparatus automatically or not, based on the evaluation points.

In the nutritional guidance apparatus according to the present invention, the acceptance means may be formed so as to accept a notice of completion that indicates the completion of printing of nutritional guidance information, so as to utilize the notice of completion of printing of nutritional guidance information as an access permission to the nutritional guidance information.

In the recording medium according to the present invention, the computer program may further include a procedure that allows a computer to accept a notice of completion indicating the completion of printing of nutritional guidance information and a procedure that allows a computer to utilize the notice of completion of printing of nutritional guidance information as an access permission to the nutritional guidance information.

With the above described nutritional guidance system, nutritional guidance apparatus and recording medium, the date of printing of nutritional guidance information is accepted as an access permission to the nutritional guidance information. In a case where a doctor prints out nutritional guidance information utilizing the third terminal apparatus, there is a high probability that a nutritional guidance prescription to be given to a patient is printed out after nutritional guidance by a dietitian has been confirmed and a comment has been inputted into the nutritional guidance information. Accordingly, an access permission can be given at the stage when the confirmation of the nutritional guidance and the input of a comment have been completed by the doctor and a nutritional guidance prescription to be given to the patient has been printed out. At this time, since the printed nutritional guidance prescription is a document to be given to the patient, no problem occurs when the printed nutritional guidance information is perused by the patient. In addition, since the nutritional guidance prescription is printed out and given to the patient at the time of diagnosis and the patient receives the doctor's diagnosis before accessing the nutritional guidance information, nutritional guidance can be carried out not only through a communications network but can also be carried out at the time of the doctor's diagnosis.

The above and further objects and features of the invention will more fully be apparent from the following detailed description with accompanying drawings.

### BRIEF DESCRIPTION OF THE SEVERAL VIEWS OF THE DRAWINGS

FIG. 1 is a diagram showing an example of a conventional nutritional guidance procedure;

FIG. 2 is a diagram showing an example of a nutritional guidance system according to the present invention;

FIG. 3 is a diagram showing a configuration example of a server shown in FIG. 2;

FIGS. 4A through 4D are diagrams showing examples of information stored in the server shown in FIG. 2;

FIG. 5A is a diagram showing an example of instruction information stored in the server shown in FIG. 2;

FIG. 5B is a diagram showing an example of medical information stored in the server shown in FIG. 2;

FIG. 6A is a diagram showing an example of menu information stored in the server shown in FIG. 2;

FIG. 6B is a diagram showing an example of measurement information stored in the server shown in FIG. 2;

FIGS. 7A and 7B are diagrams showing examples of diet information stored in the server shown in FIG. 2;

FIGS. 8A through 8C are diagrams showing examples of guidance information stored in the server shown in FIG. 2;

FIG. 9 is a diagram showing a configuration example of a terminal for a doctor shown in FIG. 2;

FIG. 10 is a flowchart showing an example of an input procedure of guidance information by a dietitian;

FIG. 11 is a diagram showing an example of an input procedure of guidance information by a dietitian;

FIG. 12 is a flowchart showing an example of an input procedure of guidance information by a doctor;

FIG. 13 is a diagram showing an example of a perusal procedure of guidance information by a patient;

FIG. 14 is a diagram showing an example of an evaluation table stored in the server shown in FIG. 2;

FIG. 15 is a flowchart showing an example of a nutritional guidance procedure; and

FIG. 16 is a diagram showing another example of an input procedure of guidance information by a doctor.

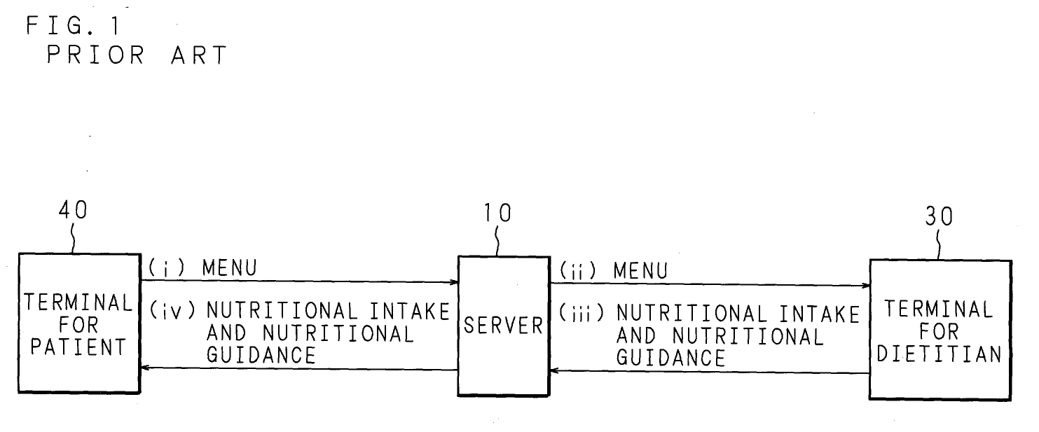

### DETAILED DESCRIPTION OF THE INVENTION

The following description will explain the present invention in detail based on the drawings illustrating some embodiments thereof.

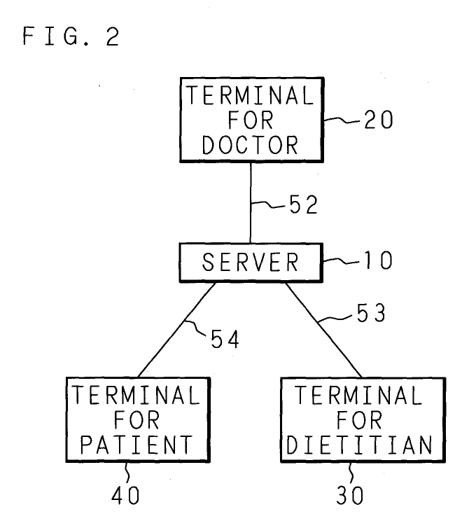

FIG. 2 shows an example of a nutritional guidance system according to the present invention. In FIG. 2, a terminal (third terminal apparatus) 20 for a doctor, a terminal (second terminal apparatus, second apparatus) 30 for a dietitian and a terminal (first terminal apparatus, first apparatus) 40 for a patient are connected to a server (nutritional guidance apparatus, central unit) 10.

The server 10 is connected with the terminal 40 for a patient through a communications network 54, such as the Internet. The server 10 is connected with the terminal 20 for a doctor and the terminal 30 for a dietitian through a dedicated line or through a communications network 52, 53, such as the Internet. The server 10 accepts menu information from the terminal 40 for a patient and stores it. In addition, the server 10 accepts nutritional intake (in particular, calorie intake) data based on the accepted menu information and nutritional guidance (dietary habit guidance) data based on the calorie intake from the terminal 30 for a dietitian that has accessed the accepted menu information, and stores them.

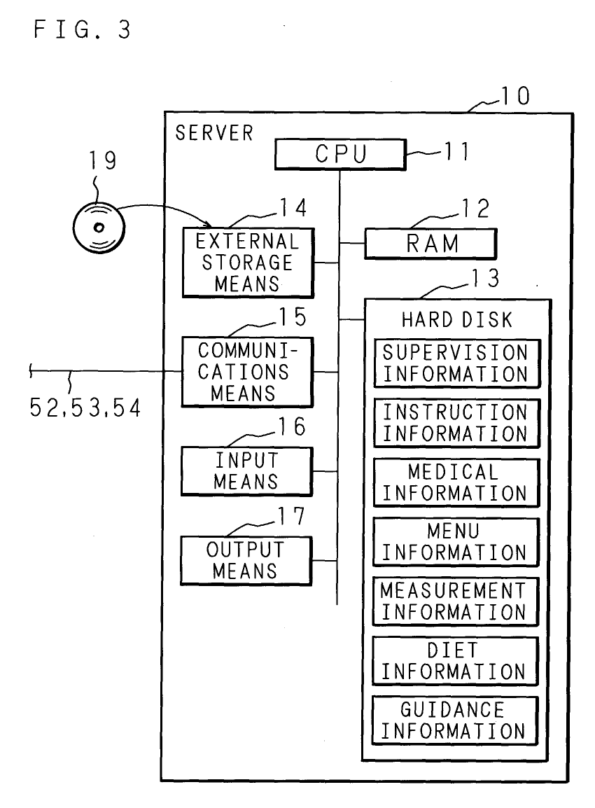

A configuration example of the server 10 is shown in FIG. 3. The server 10 is provided with a CPU (central processing unit) 11, a RAM (random access memory) 12 such as a DRAM, a hard disk 13, external storage means 14 such as a flexible disk drive or a CD-ROM drive, communications means 15 for controlling the communications with a communications network 52, 53 and 54, input means 16 such as a mouse and a keyboard, and output means 17 such as a monitor and a printer.

The CPU 11 controls the above described respective parts 12 to 17 of the server 10. The CPU 11 stores, in the RAM 12, a program or data accepted through the input means 16 or the communications means 15, or a program or data read out from the hard disk 13 or by the external storage means 14, performs a variety of processes such as execution of the program stored in the RAM 12 or the operation of data, and stores, in the RAM 12, the results of the various processes or temporary data to be used for a variety of processes. The data, such as the operation results stored in the RAM 12, is stored in the hard disk 13 or is outputted through the output means 17 or the communications means 15, by means of the CPU 11.

The communications means 15 operates as means (acceptance means) for accepting, from the terminal 20 for a doctor, an access permission to nutritional guidance information for the terminal 40 for a patient. The server 10 limits access to nutritional guidance by the terminal 40 for a patient, based on the existence of the access permission. The limitation of access can be set for each nutritional guidance prescription as described below.

The communications means 15 operates as means for accepting, from the terminal 20 for a doctor, an instruction for nutritional guidance made by a dietitian. The terminal 30 for a dietitian displays menu information and the instruction, and then prepares nutritional guidance information based on the menu information and the instruction and transmits it to the server 10.

The communications means 15 operates as means for accepting updated nutritional guidance information from the terminal 20 for a doctor. An update of nutritional guidance information is carried out by the CPU 11. In addition, the communications means 15 operates as means for accepting the date of printing of nutritional guidance information from the terminal 20 for a doctor. The date of printing of nutritional guidance information is stored in the hard disk 13 by means of the CPU 11.

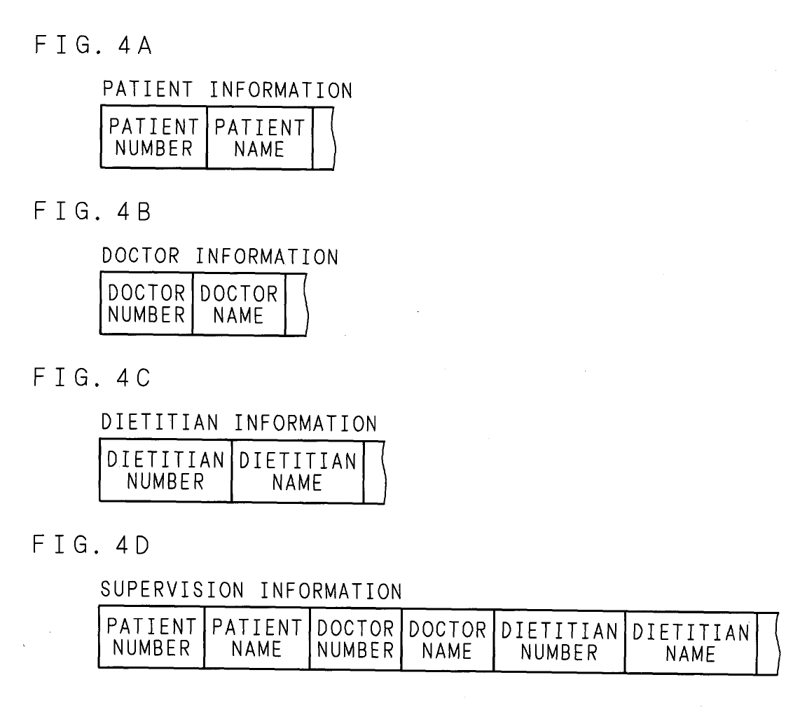

The hard disk 13 stores: patient information concerning patients who utilize the terminal 40 for a patient; doctor information concerning doctors who utilize the terminal 20 for a doctor; and dietitian information concerning dietitians who utilize the terminal 30 for a dietitian. Examples of patient information, doctor information and dietitian information are respectively shown in FIGS. 4A through 4C. Patient information includes patient numbers for identifying the respective patients and data concerning patients, such as patient names. Likewise, doctor information or dietitian information includes doctor numbers or dietitian numbers for identifying the respective doctors or respective dietitians and data concerning doctors or dietitians, such as doctor names or dietitian names.

In the present embodiment, patient information, doctor information and dietitian information include passwords to be used for accessing the server 10. In a case where the terminal 20 for a doctor, the terminal 30 for a dietitian or the terminal 40 for a patient accesses the server 10, the server 10 can identify the patient, doctor or dietitian who has made access, since the server 10 has accepted an identification number (doctor number, dietitian number or patient number) and a password.

The hard disk 13 stores supervision information indicating supervising doctors and dietitians who are in charge of the respective patients. An example of supervision information is shown in FIG. 4D. Supervision information includes patient numbers and patient names of patients, doctor numbers and doctor names of the doctors in charge of the patients, and dietitian numbers and dietitian names of dietitians in charge of the patients. Patient information, doctor information, dietitian information and supervision information are accepted through the input means 16, the external storage means 14, or the communications means 15, and are stored in the hard disk 13.

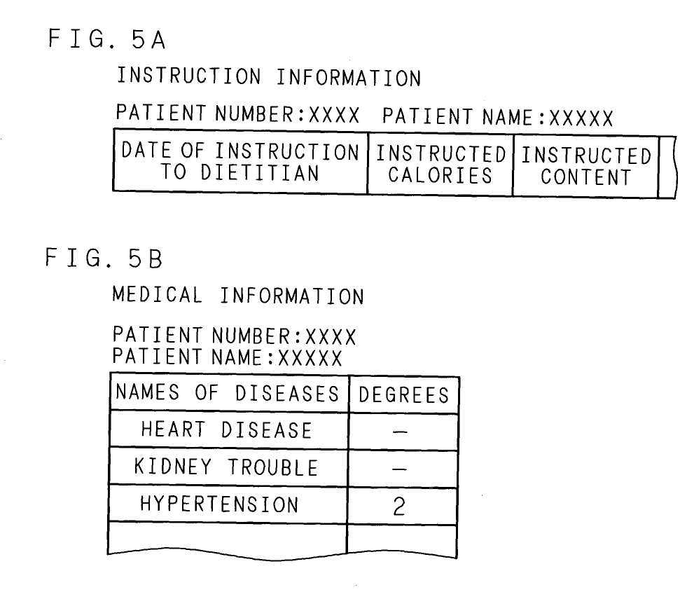

In addition, the hard disk 13 stores instruction information and medical information that have been accepted from the terminal 20 for a doctor. The instruction information includes instructions by doctors for nutritional guidance given to the respective patients by dietitians. An example of instruction information is shown in FIG. 5A. The instruction information includes the instruction date when the instructions were inputted, the instructed number of calories, the instructed content, and the like. The instructed number of calories indicates the daily calorie limit and the instructed content relates to instructions other than the number of calories. An instruction is given, for example, to advise a patient, who has stomach trouble, to follow a diet that results in a small burden on the stomach. A perusal and update of the instruction information by a doctor and a perusal of the instruction information by a dietitian are permitted.

An example of medical information is shown in FIG. 5B. Medical information includes names of diseases from which the respective patients are suffering, the degrees of severity of the diseases, and the like. The degree of severity of the disease are represented by, for example, “1” for mild symptoms, “3” for severe symptoms and “2” for symptoms between “1” and “3”, as well as by “−” for the case of no abnormality. Instruction information and medical information are accepted through the external storage means 14 or the communications means 15 and are stored in the hard disk 13.

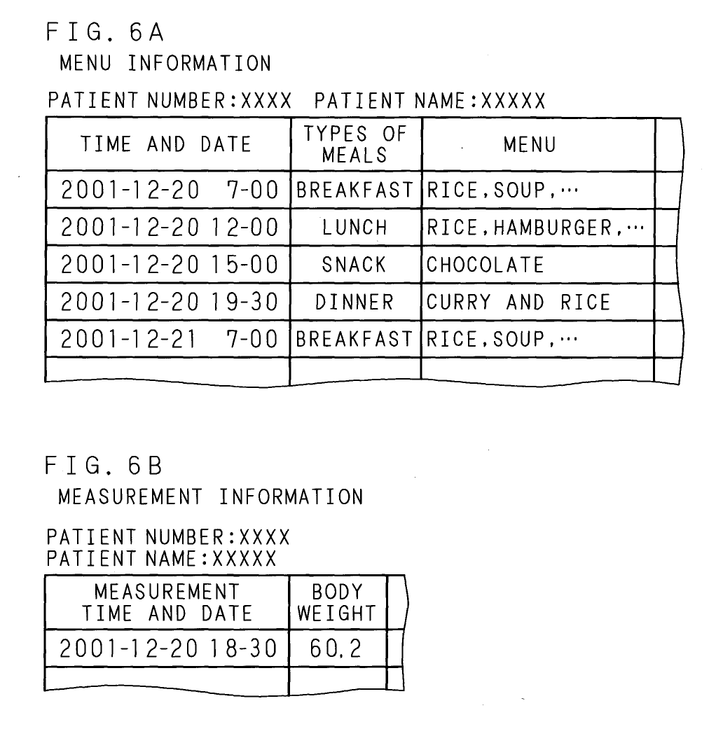

The server 10 accepts menu information concerning a diet menu from each terminal 40 for a patient and stores it in the hard disk 13. An example of menu information is shown in FIG. 6A. Menu information includes the time and date when foods are eaten, types of meals (breakfast, lunch, snack, dinner) and menus. Image data obtained by taking photographs of the foods in the diet with a digital camera can be transmitted in place of menu information.

In addition, the server 10 accepts measurement information concerning the physical condition of a patient, such as body weight, from each terminal 40 for a patient and stores it in the hard disk 13. An example of measurement information is shown in FIG. 6B. Measurement information includes the time and date when the measurement is carried out, the measured body weight, and the like. The server 10 accepts menu information or measurement information by means of the communication means 15 and stores it in the hard disk 13.

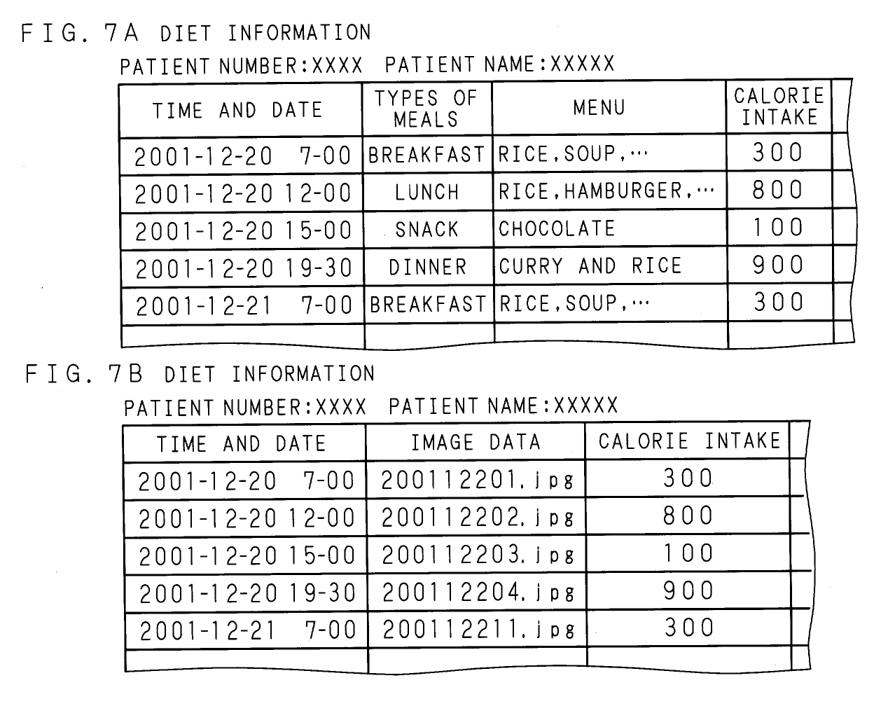

The hard disk 13 stores diet information, which includes nutritional intake (calorie intake) information accepted from a terminal 30 for a dietitian. An example of diet information is shown in FIG. 7A. Diet information is obtained by adding “calorie intake” information to menu information. In a case where image data is utilized in place of menu information, as shown in FIG. 7B, a dietitian inputs calorie intake information based on the image data. “Image data” of diet information shown in FIG. 7B is a file name of the image data and “time and date” is the time and date when the image data was prepared.

Here, the hard disk 13 may be formed so as to store the content of past nutritional guidance, daily vital sign data, disease history and the like, in addition to diet information, so that a dietitian can give nutritional guidance while perusing such information. In this case, information concerning disease history is obtained from a patient questionnaire or from a patient's electronic clinical file.

Information stored in the hard disk 13 can only be perused by the patient himself or herself, the doctor in charge and the dietitian in charge.

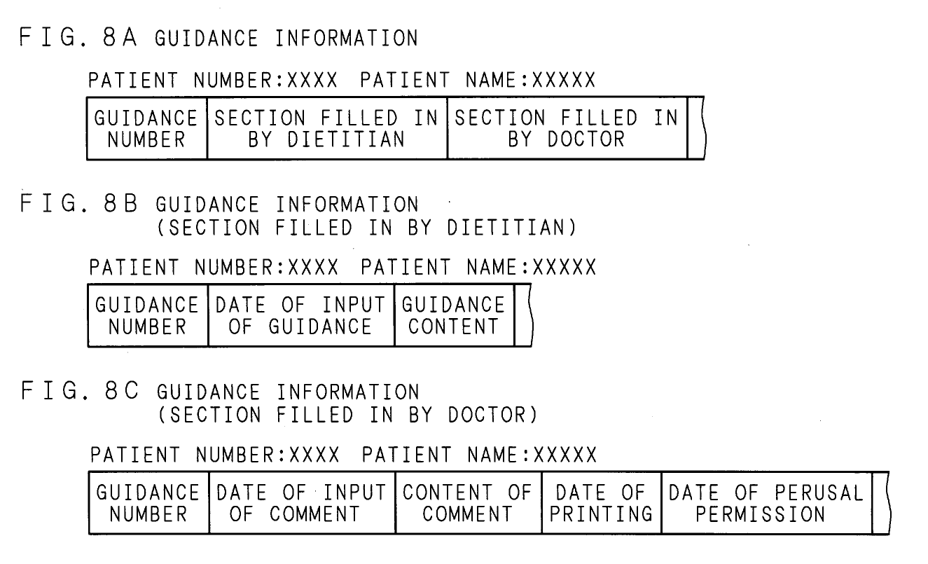

The hard disk 13 stores nutritional guidance information (guidance information) accepted from the terminal 30 for a dietitian and the terminal 20 for a doctor. Guidance information includes, as shown in FIG. 8A, a guidance number for distinguishing each case of nutritional guidance, a section filled in by a dietitian and a section filled in by a doctor. The section filled in by a dietitian is accepted from the terminal 30 for a dietitian while the section filled in by a doctor is accepted from the terminal 20 for a doctor.

An example of a section filled in by a dietitian is shown in FIG. 8B. The section filled in by a dietitian in guidance information includes a guidance number, date of input of nutritional guidance information and the content of nutritional guidance. An example of a section filled in by a doctor is shown in FIG. 8C. The section filled in by a doctor in guidance information includes a guidance number, date of input of a comment by a doctor, the content of the comment, date of printing of guidance information (section filled in by a dietitian and section filled in by a doctor) and date of perusal permission to the patient. The section filled in by a dietitian is permitted to be perused by the doctor, perused and updated by the dietitian, and perused by the patient, while the section filled in by a doctor is permitted to be perused and updated by the doctor, perused by the dietitian and perused by the patient.

A computer program recorded on recording medium 19, such as a CD-ROM, is read out by the external storage means 14 and is stored in the hard disk 13 so as to be executed by the CPU 11, and thereby the CPU 11 can be operated as the above described respective means. In addition, a computer program can be accepted from other apparatuses connected to the communications network 52, 53 and 54 using the communication means 15 so as to be stored in the hard disk 13.

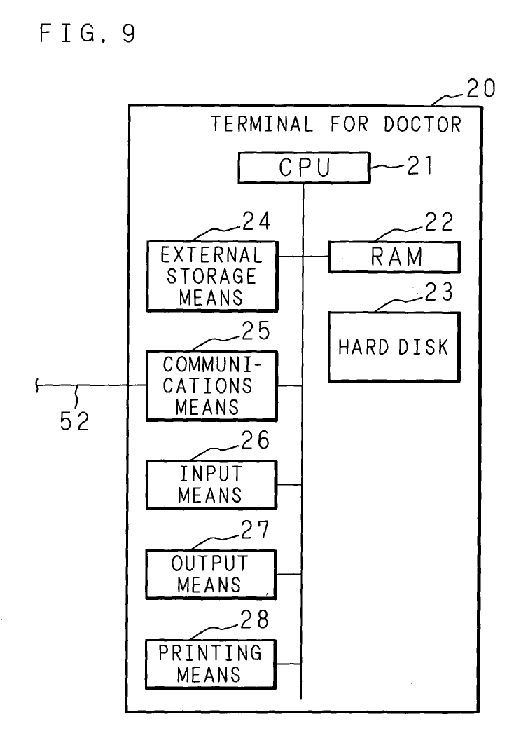

The terminal 20 for a doctor is, as shown in FIG. 9, provided with a CPU 21, a RAM 22 such as a DRAM, a hard disk 23, external storage means 24 such as a flexible disk drive or a CD-ROM drive, communication means 25 for controlling communications with the communications network 52, input means 26 such as a mouse and a keyboard, output means 27 such as a monitor, and printing means 28 such as a printer, in the same manner as the server 10.

The communication means 25 operates as means for transmitting, to the server 10, an instruction for nutritional guidance made by a dietitian. In addition, the communication means 25 operates as means for transmitting, to the server 10, an access permission to nutritional guidance information for the terminal 40 for a patient. The printing means 28 operates as means for printing out nutritional guidance information and the communication means 25 operates as means (transmission means) for transmitting date of printing of nutritional guidance information to the server 10. Transmission of date of printing is utilized as transmission of an access permission in the present embodiment. The server 10, which has accepted the date of printing, permits access to the nutritional guidance information that has been printed out.

The input means 26, the communication means 25 and the CPU 21 operate as means (update means) for updating nutritional guidance information (guidance information). A doctor inputs a comment, or the like, to the guidance information by operating the input means 26. The inputted comment is transmitted to the server 10 from the communication means 25 by means of the CPU 21. The transmitted comment is stored in the hard disk 13 of the server 10.

The computer program recorded in the recording medium, such as a CD-ROM, is read out by the external storage means 24, is stored in the hard disk 23 and is executed by the CPU 21, and thereby the CPU 21 can be operated as the above described respective means. In addition, a computer program can be accepted from other apparatuses connected to the communications network 52 using the communication means 25 so as to be stored in the hard disk 23.

Each of the terminal 30 for a dietitian and the terminal 40 for a patient is, though not shown, provided with a CPU, a RAM such as a DRAM, a hard disk, external storage means such as a flexible disk drive or a CD-ROM drive, communication means for controlling communications with the communications network 53 or 54, input means such as a mouse and a keyboard, and output means such as a monitor and a printer, in the same manner as the server 10.

Next, nutritional guidance using a nutritional guidance system according to the present invention will be described.

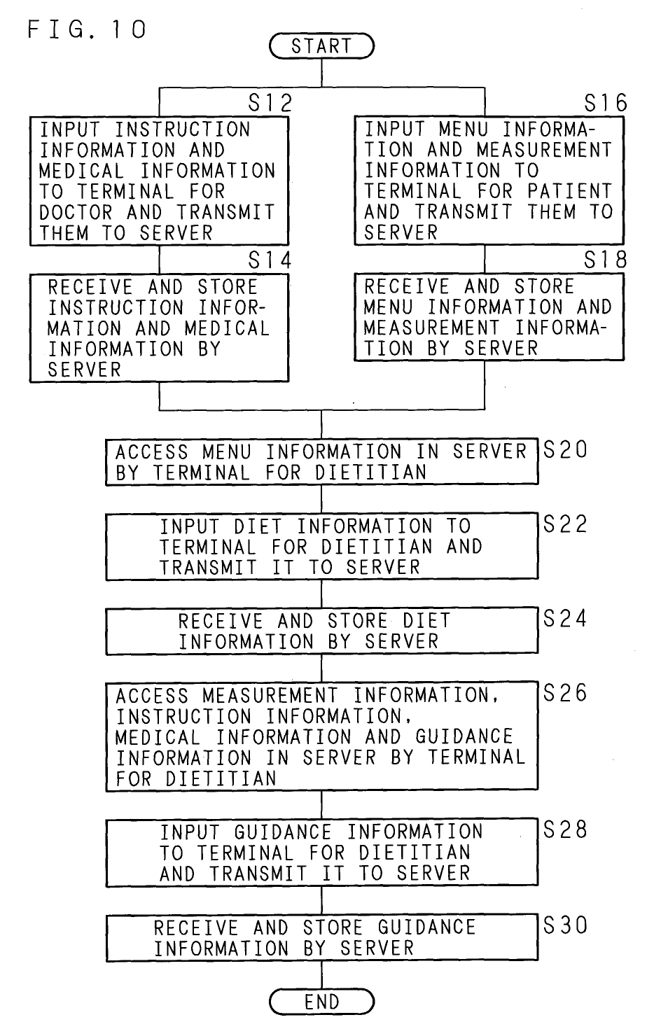

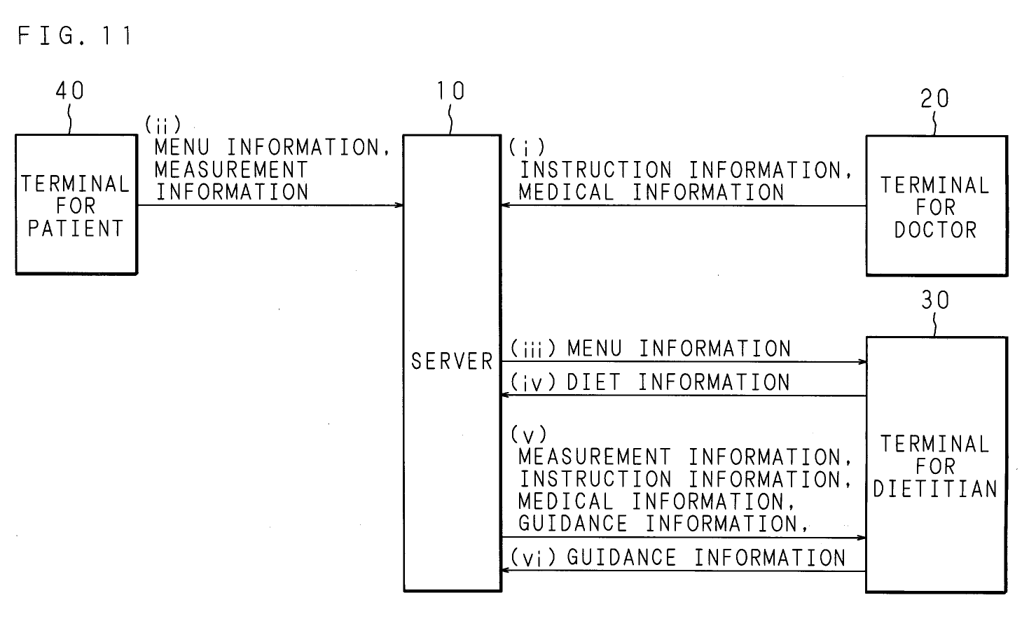

FIGS. 10 and 11 show an example of an input procedure by a dietitian of guidance information (section filled in by dietitian). First, the patient who receives nutritional guidance and supervising dietitian and doctor are registered as supervision information.

After the registration of supervision information, the supervising doctor of the patient inputs instruction information and medical information concerning the patient through the input means 26 of the terminal 20 for a doctor or the external storage means 24 (S12). The inputted instruction information and medical information are stored in the RAM 22 and are transmitted from the communication means 25 by means of the CPU 21 (S12, (i) in FIG. 11). The transmitted instruction information and medical information are received by the communication means 15 of the server 10 and are stored in the hard disk 13 by means of the CPU 11 (S14).

In addition, after registration of supervision information, the patient inputs menu information and measurement information through input means, which is not shown, of the terminal 40 for a patient (S16). The inputted menu information and measurement information are stored in a RAM, which is not shown, and are transmitted from communication means, which is not shown, by means of a CPU, which is not shown (S16, (ii) in FIG. 11). The transmitted menu information and measurement information are received by the communication means 15 of the server 10 and are stored in the hard disk 13 by means of the CPU 11 (S18). The menu information and the measurement information can be transmitted each time they are inputted or can be transmitted at one time by collecting a plurality of inputs. In the present embodiment, the menu information and measurement information are transmitted once per day.

A dietitian accesses the menu information stored in the hard disk 13 of the server 10 from communication means, which is not shown, of the terminal 30 for a dietitian (S20, (iii) in FIG. 11). The dietitian inputs diet information through input means, which is not shown, based on the menu information (S22). For inputting diet information based on the menu information shown in FIG. 6A, for example, nutritional intake, including calorie intake, of each meal menu is calculated and inputted. In a case where the menu information is image data obtained by taking photographs of the food, the content of the menu, or the like, is inputted based on the image data, and then nutritional intake, including calorie intake, of each meal menu is calculated and inputted.

The inputted diet information is stored in a RAM, which is not shown, and is transmitted from communication means, which is not shown, by means of a CPU, which is not shown (S22, (iv) in FIG. 11). The transmitted diet information is received by communication means 15 of the server 10 and is stored in the hard disk 13 by means of the CPU 11 (S24). In the present embodiment, the diet information is transmitted when required.

In addition, the dietitian accesses the measurement information, the instruction information, the medical information and the guidance information stored in the hard disk 13 of the server 10 from communication means, which is not shown, of the terminal 30 for a dietitian and peruses them (S26, (v) in FIG. 11). Here, the above described diet information is assumed to be stored in a hard disk, which is not shown, of the terminal 30 for a dietitian. The server 10 is accessed in a case where the diet information is not stored in a hard disk. The dietitian inputs guidance information (section filled in by a dietitian) through input means, which is not shown, based on the measurement information, the instruction information, the medical information and the guidance information as well as the diet information (S28). Here, the guidance information (section filled in by a doctor) is used as a reference of the doctor's previous comments.

The inputted guidance information is stored in a RAM, which is not shown, and is transmitted from communication means, which is not shown, by means of a CPU, which is not shown (S28, (vi) in FIG. 11). The transmitted guidance information (section filled in by a dietitian) is received by the communication means 15 of the server 10 and is stored in the hard disk 13 by means of the CPU 11 (S30). In the present embodiment, the guidance information (section filled in by a dietitian) is transmitted once per month.

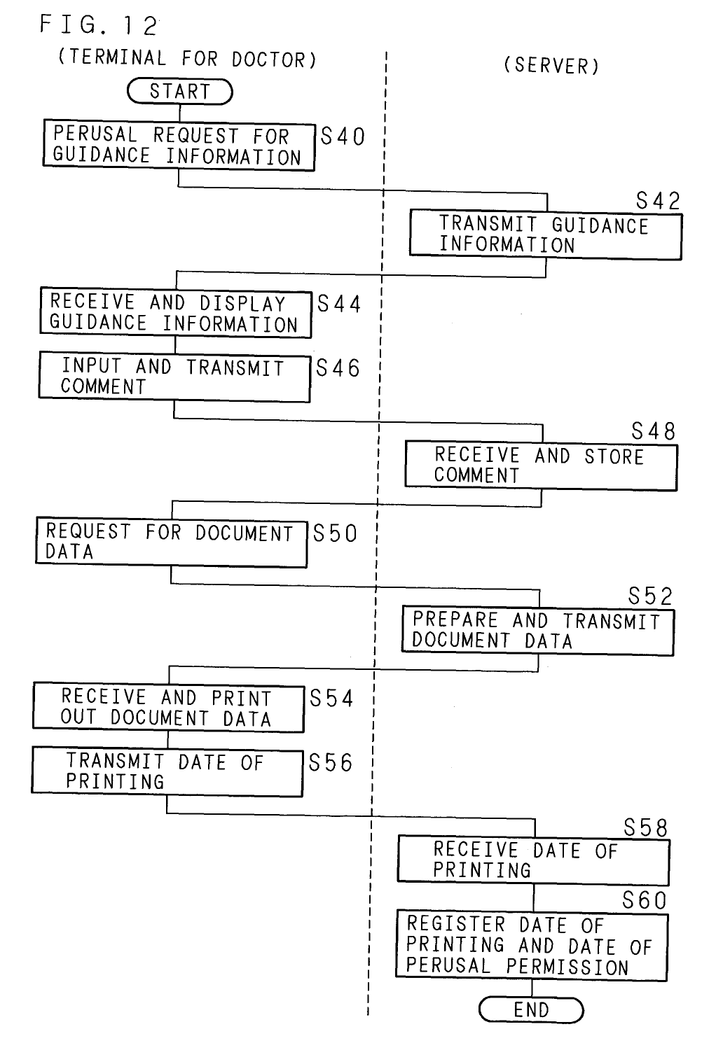

FIG. 12 shows an example of an input procedure by a doctor of guidance information (section filled in by a doctor). A doctor transmits a perusal request for guidance information (section filled in by a dietitian and section filled in by a doctor) to the server 10 from the communication means 25 of the terminal 20 for a doctor (S40). The CPU 11 of the server 10, which has received the perusal request through the communication means 15, reads out guidance information, of which the date of permission for perusal has not yet been determined, from the hard disk 13 and transmits it through the communication means 15 (S42). Here, the perusal request includes a patient number so that guidance information corresponding to the patient number is transmitted. The CPU 21 of the terminal 20 for a doctor, which has received the transmitted guidance information through the communication means 25, displays the guidance information on a display screen (output means 27) (S44).

The doctor, who has confirmed the nutritional guidance by a dietitian included in the guidance information, inputs a comment, or the like, through the input means 26 (S46). The inputted comment is stored in the RAM 22 and is transmitted through the communication means 25 by means of the CPU 21 (S46). The transmitted comment is received by the communication means 15 of the server 10 and is stored in the hard disk 13 by means of the CPU 11 (S48). In many cases, a doctor inputs a comment at the time of diagnosis of a patient. Entry of nutritional guidance information (nutritional guidance prescription) is completed at the stage where the comment is inputted.

The doctor prints out guidance information from the printing means 28 by operating the input means 26 of the terminal 20 for a doctor. Printing is performed by, for example, using a mouse (input means 26) to click a print button on the display screen. The CPU 21, which has detected that the print button has been clicked, sends a request for document data to be used for printing to the server 10 through the communication means 25 (S50). The server 10, which has received the request for document data through the communication means 15, prepares document data to be used for printing by means of the CPU 11 based on the guidance information and transmits it through the communication means 15 (S52).

The terminal 20 for a doctor, which has received the document data through the communication means 25, prints out the document data at the printing means 28 by means of the CPU 21 (S54). After the completion of printing, date of printing of guidance information (document data) is transmitted to the server 10 through the communication means 25 by means of the CPU 21 (S56). In many cases, the nutritional guidance prescription is printed out at the time of patient diagnosis. The printed nutritional guidance prescription is given to the patient by the doctor.

The transmitted date of printing is received by the communication means 15 of the server 10 (S58) and the received date of printing is registered as the guidance information by means of the CPU 11 (S60). In addition, date of perusal permission is also registered in accordance with the date of printing (S60). In the present embodiment wherein the nutritional guidance prescription is given to the patient by the doctor on the date of printing, the date of printing is assumed to be the date of perusal permission.

In a case where the server 10 has accepted an access request to guidance information (nutritional guidance prescription) from the terminal 40 for a patient through the communication means 15, a date of perusal permission when patient who has requested the access receives the perusal permission is retrieved by means of the CPU 11 and the access request is accepted or rejected in accordance with the date of perusal permission obtained in the retrieval. In the present embodiment, it becomes possible for the patient to access the guidance information stored in the server 10 when the doctor has printed out the nutritional guidance prescription and gives it to the patient.

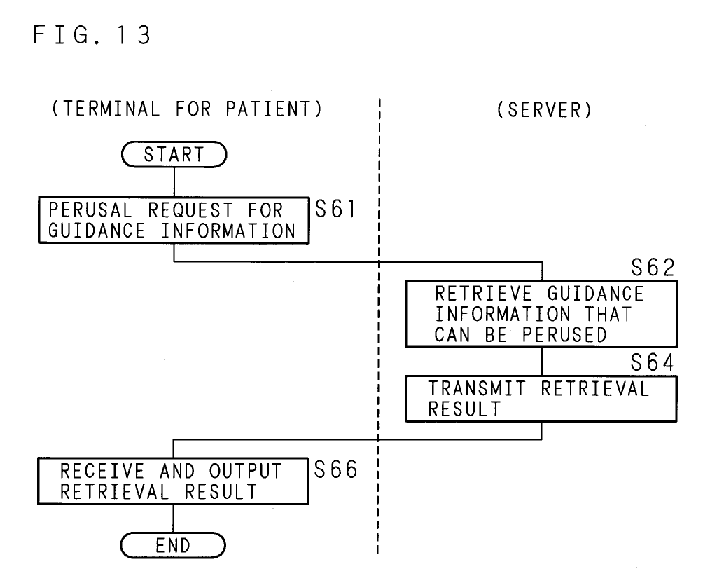

An example of a perusal procedure of guidance information (nutritional guidance prescription) by a patient is shown in FIG. 13. The patient operates input means, which is not shown, of the terminal 40 for a patient and transmits a perusal request for the guidance information through communication means, which is not shown (S61). The server 10, which has received the perusal request through the communication means 15, retrieves the guidance information that can be perused by means of the CPU 11 (S62). The CPU 11 retrieves guidance information of which the date of perusal permission is the same as, or is older than, the present date, and transmits the retrieval results through the communication means 15 (S64). The terminal 40 for a patient, which has received the retrieval results through communication means, which is not shown, outputs the retrieval results to output means, which is not shown (S66).

Here, a return (send-back) button, in addition to the print button, may be provided on the display screen of the terminal 20 for a doctor. In this case, a doctor can use a mouse to click the return button, to instruct the dietitian to modify the content of nutritional guidance. In addition, means for informing the dietitian of a problem with the content of nutritional guidance may be additionally provided.

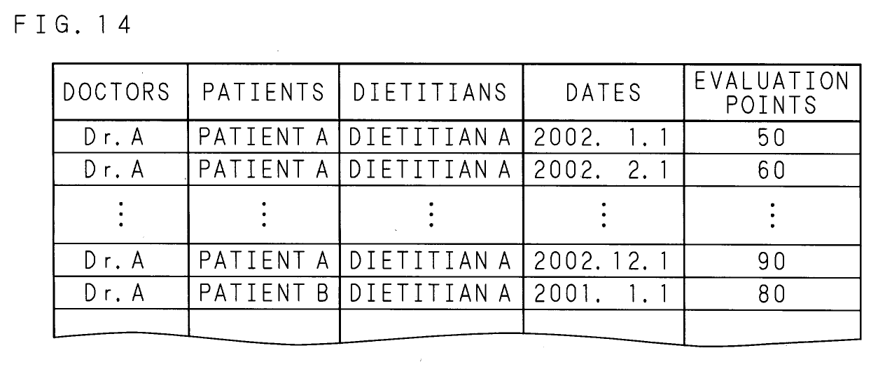

The server 10 stores an evaluation table wherein evaluation points are set for the respective combinations of doctors, patients and dietitians as shown, for example, in FIG. 14. The server 10 sets initial values of the evaluation points when the combination of doctors, patients and dietitians has been determined. After that, when a dietitian prepares a nutritional guidance prescription and a doctor gives the patient an access permission to nutritional guidance information, the evaluation points are increased, while when the doctor returns the prescription to the dietitian, the evaluation points are decreased. The doctor is allowed to peruse the evaluation table.

In addition, it is possible to set in advance whether or not an access permission to nutritional guidance information is automatically given by the server 10. In the case of automatic provision, an access permission is automatically given when a predetermined period of time has elapsed after the dietitian has prepared a nutritional guidance prescription. At this time, information indicating the entry of nutritional guidance is transmitted to the terminal 20 for a doctor after the entry of nutritional guidance information by the dietitian and before the predetermined period of time has passed for the automatic provision of an access permission. For determining whether or not an access permission to nutritional guidance information is to be automatically given, the evaluation points of the evaluation table can be referred to. In a case where an access permission to nutritional guidance information is automatically given, the evaluation points of the evaluation table do not change. In addition, automatic provision is clearly described in the nutritional guidance prescription.

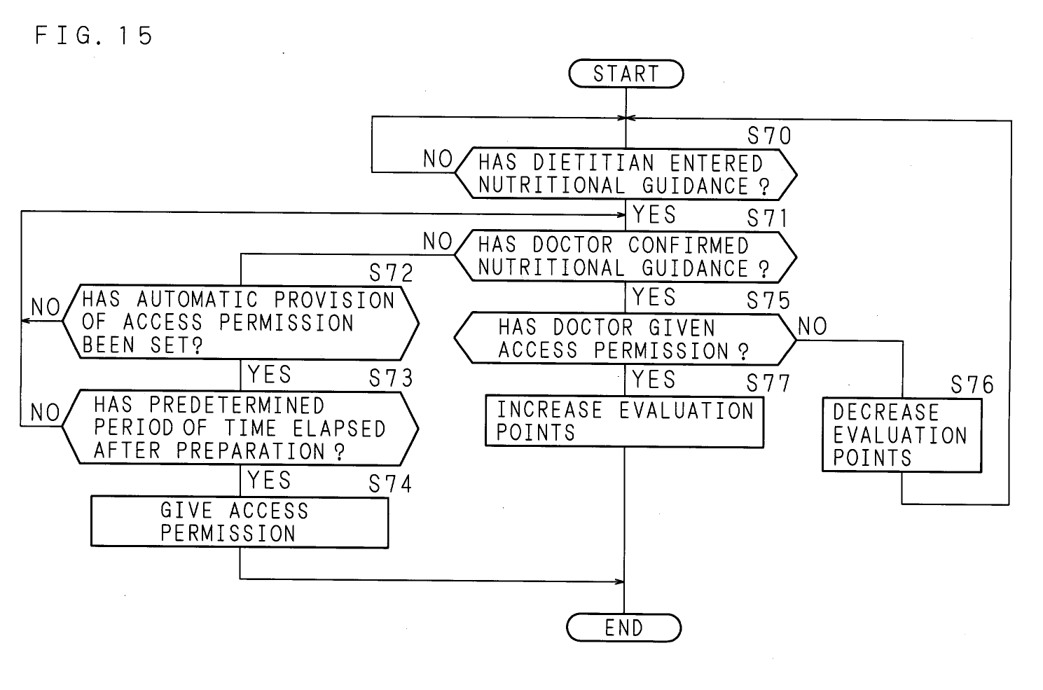

FIG. 15 shows an example of a nutritional guidance procedure. First, the server 10 determines whether or not a dietitian has entered nutritional guidance information (S70). When there is no entry (NO in step S70), the process is repeated. On the other hand, when there is an entry (YES in step S70), the server 10 determines whether or not the doctor has confirmed the nutritional guidance (S71).

When the doctor has not confirmed the nutritional guidance (NO in step S71), the server 10 determines whether or not automatic provision of an access permission to the nutritional guidance information has been set (S72), and when such a setting has not been made (NO in step S72), the procedure returns to step S71. When automatic provision of an access permission has been set (YES in step S72), the server 10 determines whether or not a predetermined period of time has elapsed after the preparation of the nutritional guidance information (S73), and when such a period of time has not elapsed (NO in step S73), the procedure returns to step S71. When the predetermined period of time has elapsed after the preparation of the nutritional guidance information (YES in step S73), the server 10 gives an access permission (S74) and transmits information indicating the automatic provision of the access permission to the terminal 20 for a doctor, and then the procedure ends.

When it is determined that the doctor has confirmed the nutritional guidance in step S71, the server 10 determines whether or not the doctor has given an access permission to the nutritional guidance information prepared by the dietitian (S75). When such an access permission has not been given (NO in step S75), the server 10 decreases the evaluation points of the corresponding combination of a doctor, a patient and a dietitian (S76) and the procedure returns to step S70. On the other hand, when an access permission has been given (YES in step S75), the server 10 increases the evaluation points of the corresponding combination of a doctor, a patient and a dietitian (S77), and the procedure ends.

Here, when an access permission to the nutritional guidance information has been given, information indicating such is transmitted to the terminal 30 for a dietitian and to the terminal 40 for a patient. In addition, when the nutritional guidance information has been returned (sent back) to the dietitian, information indicating such is transmitted to the terminal 30 for a dietitian.

Though an embodiment of the present invention has been described above, the present invention is not limited to the above described embodiment. For example, a doctor can operate the input means 26 of the terminal 20 for a doctor to transmit the access permission to the nutritional guidance information for the terminal 40 for a patient to the server through the communication means 25. In this case, the doctor can give the access permission at an arbitrary time.

In addition, the reception (S48) of the comment or the preparation (S52) of the document data shown in FIG. 12 can be regarded as an acceptance of an access permission. At the stage of the reception (S48) of the comment, the entry of the nutritional guidance prescription is completed, while at the stage of the preparation (S52) of the document data, the nutritional guidance prescription is complete and can be printed out.

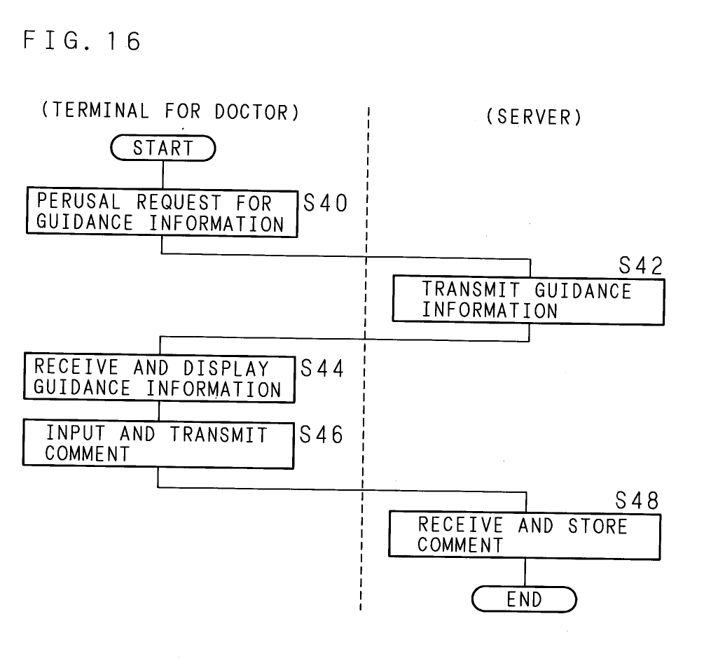

In addition, the timing of the access permission can be changed in accordance with, for example, the “degree” of the medical information. For example, in the case of mild symptoms (degree 1, degree 2), the reception (S48) of the comment after the completion of the nutritional guidance prescription as a result of entry of a comment by the doctor can be regarded as the acceptance of the access permission, as shown in FIG. 16. In this case, the patient having mild symptoms can peruse the nutritional guidance prescription by accessing the server 10 without receiving doctor's diagnosis. In the case of severe symptoms (degree 3), as shown in FIG. 12, perusal of the nutritional guidance prescription is permitted after receiving a diagnosis from the doctor.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A nutritional guidance system for providing nutritional guidance according to a menu, comprising:
a first terminal apparatus for accepting menu information of the menu;
a second terminal apparatus for displaying the accepted menu information;
a central unit for accepting and storing nutritional intake information based on the accepted menu information and nutritional guidance information concerning nutritional guidance based on the nutritional intake information; and
a third terminal apparatus for transmitting, to the central unit, an access permission to the nutritional guidance information for the first terminal apparatus,
wherein the central unit accepts an access permission from the third terminal apparatus and limits access to the nutritional guidance information by the first terminal apparatus, based on the existence of an access permission.

2. The nutritional guidance system according to claim 1,
wherein the third terminal apparatus transmits, to the central unit, an instruction for nutritional guidance, and
the central unit accepts the instruction for nutritional guidance from the third terminal apparatus and accepts nutritional guidance information concerning nutritional guidance in accordance with said accepted instruction from the second terminal apparatus, which displays the accepted instruction.

3. The nutritional guidance system according to claim 2,
wherein the third terminal apparatus comprises a controller capable of updating nutritional guidance information stored in the central unit, and
the central unit accepts an update of nutritional guidance information by the third terminal apparatus as an access permission to the nutritional guidance information.

4. The nutritional guidance system according to claim 2,
wherein the third terminal apparatus comprises a controller capable of performing the operations of:
printing out nutritional guidance information stored in the central unit; and
transmitting a notice of completion of printing to the central unit, and
the central unit accepts the notice of completion of printing of nutritional guidance information as an access permission to the nutritional guidance information.

5. The nutritional guidance system according to claim 1,
wherein the third terminal apparatus comprises a controller capable of updating nutritional guidance information stored in the central unit, and
the central unit accepts an update of nutritional guidance information by the third terminal apparatus as an access permission to the nutritional guidance information.

6. The nutritional guidance system according to claim 1,
wherein the third terminal apparatus comprises a controller capable of performing the operations of:
printing out nutritional guidance information stored in the central unit; and
transmitting a notice of completion of printing to the central unit, and
the central unit accepts the notice of completion of printing of nutritional guidance information as an access permission to the nutritional guidance information.

7. The nutritional guidance system according to claim 1,
wherein the third terminal apparatus comprises a controller capable of transmitting, to the central unit, a send-back request indicating a request for sending nutritional guidance information back to the second terminal apparatus, and
the central unit stores an evaluation table in which evaluation points changing according to an access permission or a send-back request accepted from the third terminal apparatus are set, and determines whether an access permission to the nutritional guidance information is to be transmitted to the first terminal apparatus automatically or not, based on the evaluation points.

8. The nutritional guidance system according to claim 1,
wherein the third terminal apparatus comprises update means for updating nutritional guidance information stored in the central unit, and
the central unit accepts an update of nutritional guidance information by the third terminal apparatus as an access permission to the nutritional guidance information.

9. The nutritional guidance system according to claim 1,
wherein the third terminal apparatus comprises:
printing means for printing out nutritional guidance information stored in the central unit; and
transmission means for transmitting a notice of completion of printing to the central unit, and
the central unit accepts the notice of completion of printing of nutritional guidance information as an access permission to the nutritional guidance information.

10. The nutritional guidance system according to claim 1,
wherein the third terminal apparatus comprises means for transmitting, to the central unit, a send-back request indicating a request for sending nutritional guidance information back to the second terminal apparatus, and
the central unit stores an evaluation table in which evaluation points changing according to an access permission or a send-back request accepted from the third terminal apparatus are set, and determines whether an access permission to the nutritional guidance information is to be transmitted to the first terminal apparatus automatically or not, based on the evaluation points.

11. A nutritional guidance apparatus for providing nutritional guidance according to a menu, comprising:
a controller capable of performing the operations of:
accepting menu information of the menu from a first apparatus;
accepting nutritional intake information based on said accepted menu information and nutritional guidance information concerning nutritional guidance based on the nutritional intake information from a second apparatus, which displays the accepted menu information; and
accepting an access permission to the nutritional guidance information for the first apparatus; and
a storage unit for storing the nutritional intake information and the nutritional guidance information,
whereby access to the nutritional guidance information by the first apparatus is limited based on the existence of an access permission.

12. The nutritional guidance apparatus according to claim 11,
wherein the controller accepts an instruction for nutritional guidance,
whereby nutritional guidance information concerning nutritional guidance in accordance with said accepted instruction is accepted from the second apparatus, which displays the accepted instruction.

13. The nutritional guidance apparatus according to claim 12,
wherein the controller accepts a notice of completion indicating the completion of printing of nutritional guidance information,
whereby the notice of completion of printing of nutritional guidance information is utilized as an access permission to said nutritional guidance information.

14. The nutritional guidance apparatus according to claim 11,
wherein the controller accepts a notice of completion indicating the completion of printing of nutritional guidance information,
whereby the notice of completion of printing of nutritional guidance information is utilized as an access permission to said nutritional guidance information.

15. A nutritional guidance apparatus for providing nutritional guidance according to a menu, comprising:
means for accepting menu information of the menu from a first apparatus;
means for accepting nutritional intake information based on said accepted menu information and nutritional guidance information concerning nutritional guidance based on the nutritional intake information from a second apparatus, which displays the accepted menu information;
acceptance means for accepting an access permission to the nutritional guidance information for the first apparatus; and
means for storing the nutritional intake information and the nutritional guidance information,
whereby access to the nutritional guidance information by the first apparatus is limited based on the existence of an access permission.

16. The nutritional guidance apparatus according to claim 15,
wherein the acceptance means accepts an instruction for nutritional guidance,
whereby nutritional guidance information concerning nutritional guidance in accordance with said accepted instruction is accepted from the second apparatus, which displays the accepted instruction.

17. The nutritional guidance apparatus according to claim 16,
wherein the acceptance means accepts a notice of completion indicating the completion of printing of nutritional guidance information,
whereby the notice of completion of printing of nutritional guidance information is utilized as an access permission to said nutritional guidance information.

18. The nutritional guidance apparatus according to claim 15,
wherein the acceptance means accepts a notice of completion indicating the completion of printing of nutritional guidance information,
whereby the notice of completion of printing of nutritional guidance information is utilized as an access permission to said nutritional guidance information.

19. A recording medium that is readable by a computer for recording a computer program that allows a computer to accept menu information from a first apparatus, to accept nutritional intake information based on said accepted menu information and nutritional guidance information concerning nutritional guidance based on the nutritional intake information from a second apparatus, which displays the accepted menu information, and to store the nutritional intake information and the nutritional guidance information,
wherein the computer program comprises:
a procedure for allowing a computer to accept an access permission to the nutritional guidance information for the first apparatus; and
a procedure for allowing a computer to limit access to the nutritional guidance information by the first apparatus, based on the existence of an access permission.

20. The recording medium according to claim 19, wherein the computer program further comprises:
a procedure for allowing a computer to accept an instruction for nutritional guidance; and
a procedure for allowing a computer to accept nutritional guidance information concerning nutritional guidance in accordance with said accepted instruction from the second apparatus, which displays the accepted instruction.

21. The recording medium according to claim 20, wherein the computer program further comprises:
a procedure for allowing a computer to accept a notice of completion indicating completion of printing of nutritional guidance information; and
a procedure for allowing a computer to utilize the notice of completion of printing of nutritional guidance information as an access permission to said nutritional guidance information.

22. The recording medium according to claim 19, wherein the computer program further comprises:
a procedure for allowing a computer to accept a notice of completion indicating completion of printing of nutritional guidance information; and
a procedure for allowing a computer to utilize the notice of completion of printing of nutritional guidance information as an access permission to said nutritional guidance information.
